(19) United States
(12) Patent Application Publication
(10) Pub. No.: US 2019/0200714 A1
(43) Pub. Date: Jul. 4, 2019

(54) Umbrella with electronic weather display

(71) Applicant: Giovanni Frontera, Newburgh, NY (US)

(72) Inventor: Giovanni Frontera, Newburgh, NY (US)

(21) Appl. No.: 15/860,619

(22) Filed: Jan. 2, 2018

(51) Int. Cl. A45B 25/00; A45B 23/00; H04W 4/80; H04W 4/021; G06F 13/42; G06F 1/26

(52) U.S. Cl. CPC A45B 25/00; A45B 23/00; H04W 4/80; H04W 4/90; G06F 13/4282; G06F 1/266; A45B 2023/0012; H04W 4/021

(57) ABSTRACT

The invention is directed to an umbrella with electronic weather display. The umbrella provides a digital display in the shaft of the umbrella to provide vital information such as weather forecasts and traffic alerts. The umbrella further provides one or more Universal Service Bus (USB) ports for the recharging of other electronic devices, and is powered by a combination of solar panels and a removable, rechargeable battery pack. Alternate embodiments include a hand-held umbrella, a canopy umbrella intended for use at the center of a patio table, and a beach umbrella.

### CROSS-REFERENCE TO RELATED APPLICATIONS

This application relates back to, and claims the priority of Provisional Patent Application No. 62/497,491 filed on Dec. 30, 2016.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to personal accessories and in particular to an umbrella with electronic weather display. Simply riding mass transit to work, school, or shopping is rarely as simple and relaxing as it was years ago, and the availability of electronic devices has provided ways to restore some predictability and peace of mind. Weather reports from various websites and news services have become useful in helping people plan the day. Also, local mass transit and traffic authorities have been very diligent about reporting slowdowns and traffic jams along specific routes, caused by accidents or mechanical failures. Unfortunately, the proliferation of items carried by the typical shopper or commuter leaves little room for a device to keep track of weather and traffic alerts.

A search of the prior art reveals various devices which have been developed to address this set of problems, or related problems. None are closely related to the present invention, but several include features which resemble those of the present invention. Each has proven to be less than satisfactory for the present purpose in its own way.

Weather forecasting umbrella, U.S. Patent Appl. No. 20070256716A1 (priority Sep. 19, 2001), provides a umbrella includes a display device in the umbrella's handle that provides a visual indication of the day's weather, such as the probability of precipitation. The display device may take the form of one or more lamps that emit a color, or flash at a varying rate, to indicate forecast weather conditions. The weather forecast that is displayed is preferably obtained using a wireless receiver built into the umbrella that receives data via a wireless paging or cell broadcast network. A display screen may be used to display forecasted information in more detail, including the likelihood of precipitation and/or the forecast high and low temperature for the day.

Sunshades with solar power supplies for charging electronic devices, U.S. Patent Appl. No. 2015/0216273A1 (priority Jan. 6, 2014), provides a device which includes a frame structure; a shade attached to the frame structure; and a pole attached to the frame structure. The device includes a solar panel attached to the frame structure and positioned above the shade. The frame and the shade unfold upward along the pole to open the shade. The solar panel rotates up as the frame and shade unfold upward. The frame and the shade fold down along the pole to close the shade. The solar panel rotates down as the frame and shade fold down.

Umbrella base with power supply, U.S. Pat. No. 7,614,600 (priority Dec. 29, 2003), provides an umbrella body portion containing a power source for powering umbrella lights or electrical devices or appliances used around the umbrella or other furniture accessory held by the base. A power console is provided for use on or above the base to provide connectivity to the power supply.

Some of the prior art inventions present certain disadvantages. The present invention has been developed for the purpose of addressing and resolving these disadvantages. The best way to enable these individuals to travel light is to combine multiple functions into a single, functional item that is easy to carry. An umbrella with electronic weather display, which provides a digital display in the shaft of the umbrella to provide vital information such as weather forecasts and traffic alerts, along the interior perimeter of the canopy in a range of sizes for different items, would resolve these problems.

### SUMMARY OF THE INVENTION

Accordingly, the invention is directed to an umbrella with electronic weather display. The umbrella provides a digital display in the shaft of the umbrella to provide vital information such as weather forecasts and traffic alerts. The umbrella further provides one or more Universal Service Bus (USB) ports for the recharging of other electronic devices, and is powered by a combination of solar panels and a removable, rechargeable battery pack. Alternate embodiments include a hand-held umbrella, a canopy umbrella intended for use at the center of a patio table, and a beach umbrella.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawings are included to provide a further understanding of the invention and are incorporated into and constitute a part of the specification. They illustrate three embodiments of the invention and, together with the description, serve to explain the principles of the invention.

FIG. 1 shows a side view of the first exemplary embodiment, displaying the hand-held umbrella 10A, the shaft 11, the electronic weather display 12, the USB port 13, and the handgrip 14A.

FIG. 2 shows a side view of the second exemplary embodiment on a stand, displaying the canopy umbrella 10B, the shaft 11, the electronic weather display 12, and the USB port 13.

FIG. 3 shows a side view of the third exemplary embodiment, displaying the beach umbrella 10C, the shaft 11, the electronic weather display 12, the USB port 13, and the spike 14B.

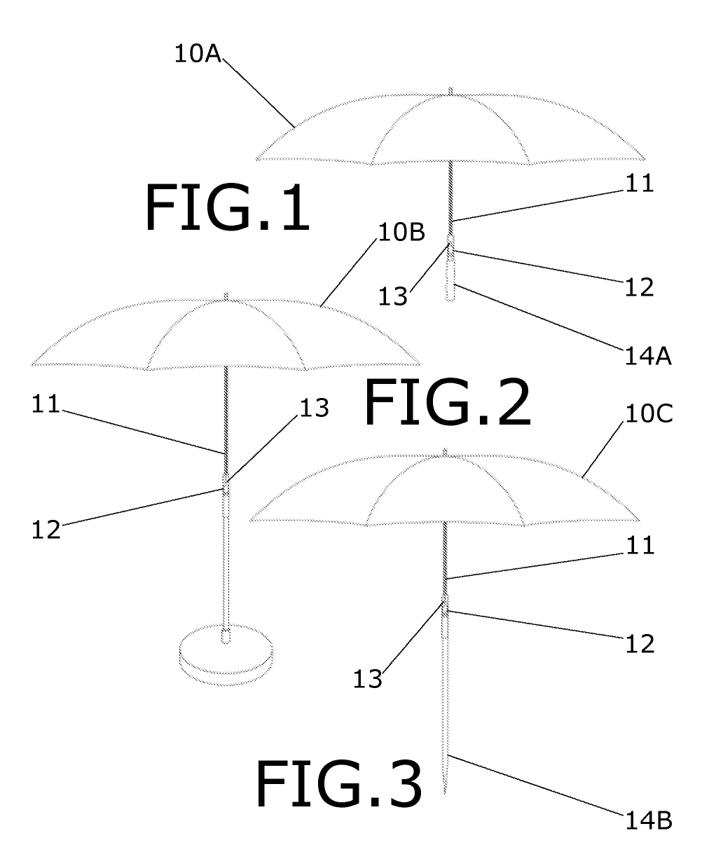

### DETAILED DESCRIPTION OF THE INVENTION

Referring now to the invention in more detail, the invention is directed to an umbrella with electronic weather display 12.

The first exemplary embodiment is comprised of a hand-held umbrella 10A, which provides a shaft 11 and all other components of a conventional hand-held umbrella. The following detailed description of the invention is focused upon ways in which the invention differs from conventional umbrellas. The shaft 11 of the hand-held umbrella 10A further provides an electronic weather display 12, which is powered by a combination of solar panels and a removable, rechargeable battery pack. The battery pack is preferably designed for quick and easy removal from the shaft 11, and replacement within or on the shaft 11, without the use of any tools. Optionally, the battery pack may provide additional features, such as a flashlight function, such that the battery pack may be operated as a flashlight once it is removed from the shaft 11 of the hand-held umbrella 10A.

The electronic weather display 12 operates on WiFi or some other short range electronic communications medium, to gain access to the Internet or some other communications network. From the communications network, the electronic weather display 12 uses a pre-installed mobile application to acquire information about local weather conditions and forecasts, and traffic information including delays in the user's vicinity due to such factors as vehicle accidents, highway construction, and mechanical breakdowns by mass transit units. This information is then displayed in an easy-to-read digital format. The electronic weather display 12 may optionally provide an audible alert, such as a beeping noise, upon acquisition of information about a weather emergency, such as a flash flood warning, a tornado warning, or a thunderstorm warning.

Optionally, the electronic weather display 12 may provide other functions consistent with hand-held electronic devices, such as an emergency cellular phone function which may be used to instantly place a cellular phone call to an emergency dispatcher, a camera function, an Internet browsing function, a gaming function, or some combination of these functions. Electronic components of the electronic weather display 12 preferably include a small, digital visual display, an on/off switch, the USB ports 13, one or more solar panels, a microprocessor, a memory device, and a WiFi transmitter and receiver with internal antenna.

Immediately above the electronic weather display 12, the shaft 11 further provides one or more Universal Service Bus (USB) ports 13, enabling the user to recharge a smartphone, tablet, or other mobile electronic device. Ideally, two USB ports 13 are provided. The USB ports 13 may optionally be capable of use for transferring data to the electronic weather display 12. The lower end of the shaft 11 terminates in a handgrip 14A.

The second exemplary embodiment is similar in structure and function to the first exemplary embodiment, with the following modifications. Instead of a hand-held umbrella 10A, the second exemplary embodiment provides a canopy umbrella 10B which is intended for use at the center of a patio table, or as part of some other outdoor furniture. The second exemplary embodiment is therefore substantially larger than the first exemplary embodiment. Ideally, four USB ports 13 are provided. The second exemplary embodiment does not provide a handgrip 14A.

The third exemplary embodiment is similar in structure and function to the second exemplary embodiment, with the following modifications. Instead of a canopy umbrella 10B, the third exemplary embodiment provides a beach umbrella 10C which is intended for use at the beach or some other outdoor area. The third exemplary embodiment is therefore substantially larger than the first exemplary embodiment, and roughly the same size as the second exemplary embodiment. The lower end of the shaft 11 terminates in a spike 14A, which may be driven into the sand, soil, or other ground surface to secure the beach umbrella 10C in a vertical or close-to-vertical angle relative to the ground. Ideally, four USB ports 13 are provided.

The electronic weather display 12 and the USB ports 13 are preferably manufactured from rigid, durable materials such as steel, aluminum alloy, ceramics, copper alloy, plastic, and brass. The shaft 11, the handgrip 14A, and the stake 14B are preferably manufactured from rigid, durable materials of substantial structural strength which are corrosion resistant, such as stainless steel, brass, hardwood, and aluminum alloy. The handgrip 14A may be covered by a decorative material such as polished hardwood or leather. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An umbrella with electronic weather display, comprised of a shaft and all other components of a conventional hand-held umbrella, wherein the shaft of the umbrella provides an electronic weather display powered by a combination of solar panels and a removable, rechargeable battery pack, and the lower end of the shaft terminates in a handgrip.

2. The umbrella of claim 1, wherein the battery pack is preferably designed for quick and easy removal from the shaft, and replacement within or on the shaft, without the use of any tools.

3. The umbrella of claim 1, wherein the battery pack may provide additional features, such as a flashlight function, such that the battery pack may be operated as a flashlight once it is removed from the shaft of the hand-held umbrella.

4. The umbrella of claim 1, wherein the electronic weather display operates on WiFi or some other short range electronic communications medium, to gain access to the Internet or some other communications network.

5. The umbrella of claim 1, wherein the electronic weather display uses a pre-installed mobile application to acquire information from the communications network about local weather conditions and forecasts, and traffic information including delays in the user's vicinity, displaying this information in an easy-to-read digital format.

6. The umbrella of claim 1, wherein the electronic weather display may optionally provide an audible alert, such as a beeping noise, upon acquisition of information about a weather emergency, such as a flash flood warning, a tornado warning, or a thunderstorm warning.

7. The umbrella of claim 1, wherein the electronic weather display may provide other optional functions consistent with hand-held electronic devices, such as an emergency cellular phone function which may be used to instantly place a cellular phone call to an emergency dispatcher, a camera function, an Internet browsing function, a gaming function, or some combination of these functions.

8. The umbrella of claim 1, wherein immediately above the electronic weather display, the shaft further provides one or more Universal Service Bus (USB) ports, enabling the user to recharge a smartphone, tablet, or other mobile electronic device, and optionally enabling the user to transfer data to the electronic weather display.

9. The umbrella of claim 1, wherein the electronic components of the electronic weather display preferably include a small, digital visual display, an on/off switch, one or more USB ports, one or more solar panels, a microprocessor, a memory device, and a WiFi transmitter and receiver with internal antenna.

10. The umbrella of claim 1, wherein the electronic weather display and the USB ports are preferably manufactured from rigid, durable materials such as steel, aluminum alloy, ceramics, copper alloy, plastic, and brass, and the shaft is preferably manufactured from rigid, durable materials of substantial structural strength which are corrosion resistant, such as stainless steel, brass, hardwood, and aluminum alloy.

11. The umbrella of claim 1, wherein the handgrip is eliminated and the umbrella is a large canopy umbrella which is intended for use at the center of a patio table, or as part of some other outdoor furniture.

12. The umbrella of claim 1, wherein the handgrip is eliminated and the umbrella is a large beach umbrella 10C which is intended for use at the beach or some other outdoor area.

13. The umbrella of claim 11, wherein the lower end of the shaft terminates in a spike, which may be driven into the sand, soil, or other ground surface to secure the beach umbrella in a vertical or close-to-vertical angle relative to the ground.
